(19) United States
(12) Patent Application Publication
(10) Pub. No.: US 2026/0219557 A1
(43) Pub. Date: Jul. 30, 2026

(54) CAMERA STRUCTURE

(71) Applicant: SHARETRONIC DATA TECHNOLOGY CO., LTD., Shenzhen City (CN)

(72) Inventors: Kangming GENG, Shenzhen City (CN); Zhou YI, Shenzhen City (CN); Zhaotian QU, Shenzhen City (CN); Jianfei LIU, Shenzhen City (CN)

(21) Appl. No.: 19/178,041

(22) Filed: Apr. 14, 2025

(30) Foreign Application Priority Data
Jan. 27, 2025 (CN) 202510126423.6
Jan. 27, 2025 (CN) 202520176236.4

(51) Int. Cl. G03B 17/14

(52) U.S. Cl. CPC G03B 17/14

(57) ABSTRACT

The present disclosure provides a camera structure, including a lens assembly, a suction cup, and a locking mechanism. The lens assembly includes a housing and a lens. The suction cup defines a first through hole. The lens is in an interference fit with the first through hole. The suction cup is configured to be adhered to a carrier. The locking mechanism is sleeved on a connecting position of the lens and the suction cup. The locking mechanism includes a rotating disk and a clamping disk. The clamping disk is located between the suction cup and the rotating disk. The clamping disk includes at least one rotating slope structure with a first position and a second direction. When the rotating disk is engaged with first position, the locking mechanism is in a locked state. When the rotating disk is engaged with second position, the locking mechanism is in an unlocked state.

### CROSS-REFERENCE TO RELATED APPLICATIONS

This application claims priority to and the benefits of Chinese Application Patent Application No. 202520176236.4, filed on Jan. 27, 2025, and Chinese Application Patent Application No. 202510126423.6, filed on Jan. 27, 2025, and the entire disclosure of which are hereby incorporated by reference.

### TECHNICAL FIELD

The present disclosure relates to technical fields of camera structures, and in particular relates to a camera structure with a built-in suction cup.

### BACKGROUND

In practical applications, vacuum suction cups are quite common, and in the field of cameras, structures where the camera and the suction cup mount are separate are also prevalent. However, integrated structures combining the camera and the suction cup mount are relatively rare. Existing structure with separate camera and suction cup mount often involve a cumbersome installation process.

### SUMMARY

In view of this, the present disclosure provides a camera structure, to solve at least one of above technical problems of the prior art.

To solve the above technical problems, the present disclosure provides a camera structure. The camera structure may include a lens assembly, a suction cup, and a locking mechanism. The lens assembly may include a housing, and a lens fixedly coupled inside of the housing. The suction cup may define a first through hole. The lens is in an interference fit with the first through hole. The suction cup is configured to be adhered to a carrier, enabling the lens assembly to be attached to the carrier. The locking mechanism is sleeved on a connecting position of the lens and the suction cup. The locking mechanism may at least include a rotating disk and a clamping disk. The clamping disk is located between the suction cup and the rotating disk. The clamping disk may include at least one rotating slope structure. When the rotating disk is engaged with first position of the at least one rotating slope structure of the clamping disk, the locking mechanism is in a locked state. When the rotating disk is engaged with second position of the at least one rotating slope structure of the clamping disk, the locking mechanism is in an unlocked state.

The aforementioned camera structure simplifies the installation process by integrating the lens assembly and the suction cup. The design of the locking mechanism can control the adhesion state of the suction cup by the rotating disk engaging with the at least one rotating slope structure of the clamping disk at different positions. When the locking mechanism is in the locked state, the locking mechanism ensures that the lens assembly can be attached to the carrier firmly, guaranteeing stability. Through the interaction of the slope surface of the at least one rotating slope structure of the rotating disk and the clamping disk, the clamping disk applies a stable compressive force to the edge of the suction cup. This compressive force effectively prevents the suction cup from rebounding or allowing air ingress during the adhesion process, avoiding a reduction in adsorption force or even detachment caused by air entering the gap between the suction cup and the surface of the carrier. As a result, the camera structure remains stably adhered to the surface of the carrier, ensuring the stability and continuity of the monitoring images.

In at least one embodiment, a slope surface of the rotating slope structure is spiral-shaped.

In at least one embodiment, when the rotating disk rotates along a first direction, the rotating disk can rotate from the second position of the rotating slope structure to the first position of the rotating slope structure; when the rotating disk rotates along a second direction, the rotating disk can rotate from the first position of the rotating slope structure to the second position of the rotating slope structure, where the first direction is opposite to the second direction.

In at least one embodiment, the first position is an end portion of the rotating slope structure away from the suction cup, and the second position is an end portion of the rotating slope structure close to the suction cup.

In at least one embodiment, an inner wall of a side of the rotating disk facing the clamping disk can include at least one resisting portion, the at least one resisting portion abuts against slope surface of the at least one rotating slope structure respectively.

In at least one embodiment, the first position of the rotating slope structure of the clamping disk can include a stopping member. When the resisting portion is located in the first position, the resisting portion abuts against the stopping member.

In at least one embodiment, the lens assembly can further include a fixed component; the fixed component can define a second through hole. The second through hole can penetrate the first component in a direction parallel a central axis of the lens. The fixed component can be coupled to the housing. The lens can extend through the second through hole.

In at least one embodiment, the fixed component can include at least one first protrusion spaced apart thereon, and the first protrusion can extend radially outward along the fixed component. An inner circumferential wall of the housing can include at least one first engaging structure at corresponding position to match the at least one first protrusion respectively. When the first protrusion is engaged with the first engaging structure, the housing and the fixed component are fixedly coupled.

In at least one embodiment, a peripheral wall of the fixed component can include a second protrusion continuously distributed along a circumferential direction of the fixed component. The second protrusion can extend radially outward from the fixed component. An inner peripheral wall of the rotating disk can include at least one second engaging structure at corresponding position to engage with the second protrusion. When the second protrusion is engaged with the at least one second engaging structure, the fixed component and the rotating disk are relatively fixed in an axial direction of the fixed component.

In at least one embodiment, an edge area of the clamping disk near the suction cup can include a plurality of raised dots. A corresponding position of the suction cup near the clamping disk can include a plurality of recessed dots that engage with the plurality of raised dots respectively. When the raised dots are engaged with the recessed dots respectively, the clamping disk moves toward the suction cup.

In at least one embodiment, the camera structure can further include an elastic member located between the clamping disk and the suction cup. The elastic member can include an elastic spiral component made of elastic materials wound in a spiral.

In at least one embodiment, the suction cup is made by dual-color injection molding and can include a hard plastic part and a soft plastic part.

In at least one embodiment, an outer peripheral surface of the rotating disk can include a plurality of ribbed protrusions spaced apart. The plurality of ribbed protrusions can be arranged along a circumferential direction of the outer peripheral surface, and a surface roughness of the ribbed protrusions is greater than that of other parts of the outer peripheral surface of the rotating disk.

In at least one embodiment, the suction cup can include at least one grip part, which protrudes radially outward from the suction cup.

In at least one embodiment, the housing can define a plurality of first holes distributed along a surface of the housing.

The camera structure of the present disclosure utilizes the rotating disk and the clamping disk to cooperate for locking and unlocking. When the camera structure needs to be adhered onto the carrier, the rotating disk can be rotated along a direction to engage with the first position of the at least one rotating slope structure of the clamping disk, thereby locking the suction cup and completing the adsorption of the camera structure. By rotating the rotating disk in an opposite direction to engage with the second position of the at least one rotating slope structure of the clamping disk, unlocking can be easily achieved, enhancing the practicality and convenience of the camera structure.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skilled in the art may also obtain other drawings based on these drawings without any creative efforts.

FIG. 1 illustrates an overall structural view of a camera structure 100 in accordance with one embodiment of the present disclosure;

FIG. 2 illustrates an exploded view (1) of the camera structure 100 shown in FIG. 1.

FIG. 3 illustrates an exploded view (2) of the camera structure 100 shown in FIG. 1.

FIG. 4 illustrates a cross-sectional view of the camera structure 100 shown in FIG. 1.

FIG. 5 illustrates an exploded view of the cross-sectional view shown in FIG. 4.

FIG. 6 illustrates a partial exploded structural view (1) of the camera structure 100 shown in FIG. 2.

FIG. 7 illustrates a partial exploded structural view (2) of the camera structure 100 shown in FIG. 2.

FIG. 8 illustrates a cross-sectional view of the structure shown in FIG. 7.

FIG. 9 illustrates a partial exploded structural view (3) of the camera structure 100 shown in FIG. 2.

The reference numbers in the detailed description are as follows:
camera structure - - - 100; lens assembly - - - 110; housing - - - 112; lens - - - 113; first engaging structure - - - 114;
fixed component - - - 120; first protrusion - - - 121a; second protrusion - - - 121b; fixed edge - - - 121c; second through hole - - - 123;
locking mechanism - - - 130; rotating disk - - - 131; resisting portion - - - 131a; second engaging structure - - - 131b; ribbed protrusion - - - 131c; third through hole - - - 131d; first direction - - - a; second direction - - - b; partition plate - - - 1311; circular perimeter wall - - - 1312; first receiving space - - - 1311a; second receiving space - - - 1311b;
clamping disk - - - 132; rotating slope structure - - - 132a; stopping member - - - 132b; disk structure - - - 132c; fourth through hole - - - 132d; raised dot - - - 132f; first position - - - A; second position - - - B;
elastic member - - - 140; suction cup - - - 150; first through hole - - - 151; connecting portion - - - 152; suction cup body - - - 153; recessed dot - - - 154; grip part - - - 160; heat dissipation hole - - - 170.

### DETAILED DESCRIPTION OF ILLUSTRATED EMBODIMENTS

In order to enable those skilled in the technical field to better understand the solutions of the present disclosure, the technical solutions in the embodiments of the present disclosure will be described clearly and completely in the following with reference to the accompanying drawings in the embodiments of the present disclosure. Obviously, the described embodiments are only a part of the embodiments of the present disclosure, rather than all of them. Based on the embodiments in the the present disclosure, all other embodiments obtained by those of ordinary skill in the art without creative efforts shall fall within the protection scope of the present disclosure.

It should be understood that the terms “first”, “second”, etc. in the specification and claims of the present disclosure and the accompanying drawings are used to distinguish different objects and are not used to describe a particular order. In addition, the terms “include”, “comprise” and “have”, and any variations thereof, are intended to cover non-exclusive inclusion. For example, a process, method, system, product or device including a series of steps or units is not limited to the listed steps or units, but optionally also can include steps or units that are not listed, or optionally can include other steps or units that are inherent to the process, method, product or apparatus.

“Embodiments” in the present disclosure means that particular features, structures, or characteristics described with reference to the embodiments may be included in at least one embodiment of the present disclosure. The presence of the phrase at various places in the specification does not necessarily referring to the same embodiment, nor is it a separate or alternative embodiment that is mutually exclusive of other embodiments. It is understood by those skilled in the art, both explicitly and implicitly, that the embodiments described in the present disclosure may be combined with other embodiments.

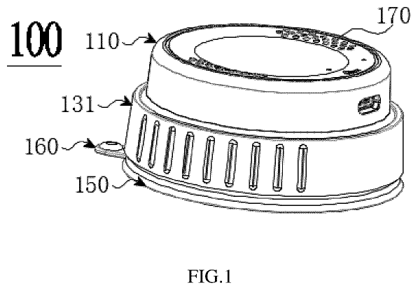

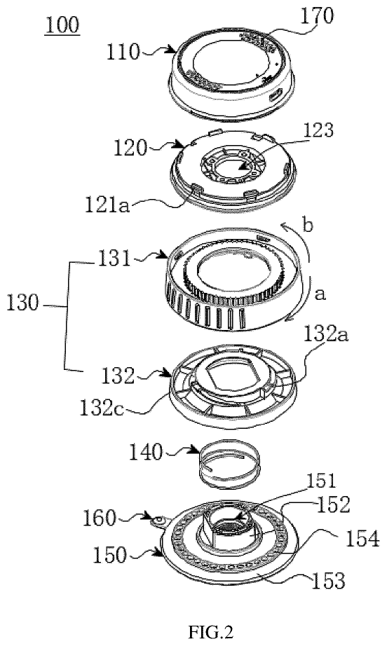

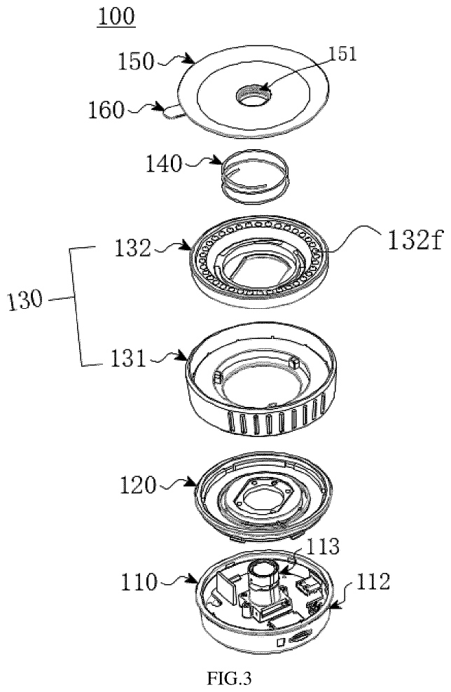

Referring to FIGS. 1 to 3, FIG. 1 illustrates an overall structural view of a camera structure 100 in accordance with one embodiment of the present disclosure; FIG. 2 illustrates an exploded view (1) of the camera structure 100 shown in FIG. 1; FIG. 3 illustrates an exploded view (2) of the camera structure 100 shown in FIG. 1. As shown in FIGS. 1 to 3, the camera structure 100 can include a lens assembly 110, a suction cup 150 and a locking mechanism 130. The lens assembly 110 can include a housing 112 and a lens 113 fixedly coupled inside of the housing 112. The suction cup 150 defines a first through hole 151. The lens 113 is in an interference fit with the first through hole 151. The suction cup 150 is configured to be adhered to a carrier, enabling the lens assembly 110 to be attached to the carrier. The locking mechanism 130 is sleeved on a connecting position of the lens 113 and the suction cup 150. The locking mechanism 130 can at least include a rotating disk 131 and a clamping disk 132. The clamping disk 132 is located between the suction cup 150 and the rotating disk 131. The clamping disk 132 can include at least one rotating slope structure 132a. When the rotating disk 131 is engaged with first position of the at least one rotating slope structure 132a of the clamping disk 132, the locking mechanism 130 is in a locked state. When the rotating disk 131 is engaged with second position of the at least one rotating slope structure 132a of the clamping disk 132, the locking mechanism 130 is in an unlocked state.

Thus, the camera structure 100 of the present disclosure can be applied to various carriers, such as transparent glass, transparent car windows, and the like. The lens 113 captures images on the opposite side of the carrier by transmitting light through the carrier. The lens 113 and the first through hole 151 on the suction cup 150 are designed with an interference fit, ensuring almost no gap between the lens 113 and the suction cup 150, which effectively prevents air circulation. When the camera structure 100 is attached to the carrier, the interference fit ensures that a relatively sealed space is formed inside the suction cup 150, providing excellent airtightness to ensure stable adsorption of the suction cup 150 on the surface of the carrier and effectively avoiding a decrease in adsorption force due to gas ingress. Additionally, the lens assembly 110, through the interference fit between the lens 113 and the suction cup 150, enables quick preliminary positioning and connection without the need for complex installation procedures.

When installing the camera structure 100, the suction cup 150 can first be aligned with the surface of the carrier. Utilizing the elasticity of the suction cup 150 itself and atmospheric pressure, the suction cup 150 can initially adhere to the carrier. Then, the locking mechanism 130 can be operated to lock the suction cup 150 in place. Since the clamping disk 132 is positioned between the suction cup 150 and the rotating disk 131, and the clamping disk 132 can include the at least one rotating slope structure 132a, the rotation of the rotating disk 131 will push the clamping disk 132 to move toward the suction cup 150 along the slope surface of the at least one rotating slope structure 132a. The movement of the clamping disk 132 ensures that the suction cup 150 remains tightly attached to the surface of the carrier, effectively preventing air ingress due to the rebound of the suction cup 150, which ensures that the camera structure 100 does not shift or fall during shooting due to insufficient adsorption force, thereby guaranteeing the stability of the shooting process.

Therein, when the rotating disk 131 is rotated to be engaged with the first position of the at least one rotating slope structure 132a of the clamping disk 132, the locking mechanism 130 is in the locked state. Under the action of the rotating disk 131, the clamping disk 132 applies a stable compressive force to the edge of the suction cup 150. This compressive force ensures that the suction cup 150 remains tightly attached to the surface of the carrier, preventing air ingress due to the rebound of the edge of the suction cup 150, thereby maintaining stable adsorption force. When the camera structure 100 needs to be mounted onto the carrier, simply rotating the rotating disk 131 to engage with the first position of the at least one rotating slope structure 132a of the locking mechanism 130, enabling the locking mechanism 130 to be in the locked state, and and achieving that camera structure 100 to be attached to the surface of the carrier. However, when disassembly or repositioning of the camera structure 100 is required, rotating the rotating disk 131 in the opposite direction to engage with the second position of the at least one rotating slope structure 132a, enabling the locking mechanism 130 to be in the unlocked state, which further enhances the stability and practicality of the camera structure 100, providing a stable shooting perspective and images.

In at least one embodiment, please continue to referring to FIGS. 2 and 3, a slope surface of the at least one rotating slope structure 132a is spiral-shaped. The rotating disk 131 engages with the at least one rotating slope structure 132a. During the rotation of the rotating disk 131, the rotational motion of the rotating disk 131 is transmitted to the spiral slope surface of the at least one rotating slope structure 132a. Since the rotating disk 131 itself is fixed in the axial direction of the camera structure 100—where the axial direction refers to the direction aligned with the central axis of the camera structure 100—the rotational motion of the rotating disk 131 drives the at least one rotating slope structure 132a to move along the axial direction of the camera structure 100, which allows the rotating disk 131 to engage with different positions of the at least one rotating slope structure 132a, thereby driving the clamping disk 132 to extend or retract relative to the rotating disk 131. This mechanism enables the adjustment of the compressive force applied by the clamping disk 132 to the suction cup 150. Moreover, the compressive force applied by the clamping disk 132 to the edge of the suction cup 150 can be smoothly adjusted, providing a gradual and continuous action path for the rotation of the rotating disk 131. During the rotation of the rotating disk 131, the operator can clearly feel the degree of rotation at each incremental angle, allowing for more accurate judgment of the state of the locking mechanism 130 and further enabling precise control over the adsorption and detachment operations of the camera structure 100.

In at least one embodiment, when the rotating disk 131 rotates along a first direction a, the rotating disk 131 rotates from a second position of the rotating slope structure 132a to a first position of the rotating slope structure 132a; when the rotating disk 131 rotates along a second direction b, the rotating disk 131 rotates from the first position of the rotating slope structure 132a to the second position of the rotating slope structure 132a. Where the first direction a is opposite to the second direction b.

Thus, when the rotating disk 131 rotates along the first direction a to the first position, the rotating disk 131 can tightly engage with the rotating slope structure 132a of the clamping disk 132, forming a locked structure. When the rotating disk 131 rotates along the second direction b to the second direction, the locked structure is released. Through this bidirectional rotation design, the rotating disk 131 and the rotating slope structure 132a of the clamping disk 132 experience more uniform force distribution during use, avoiding localized excessive wear caused by frequent unidirectional rotation. This extends the service life of the components of the locking mechanism 130 and enhances the overall durability of the camera structure 100. In some embodiments, the first direction may be clockwise, and the second direction may be counterclockwise. In other embodiments, the first direction may be counterclockwise, and the second direction may be clockwise.

In at least one embodiment, the outer peripheral surface of the rotating disk 131 may be provided with directional indicators. For example, arrows may be marked on the outer peripheral surface of the rotating disk 131 to indicate the first direction and the second direction. This effectively prevents issues such as weak adsorption of the camera structure 100 or difficulty in detachment during unlocking due to incorrect operation, thereby enhancing user experience and ensuring stable operation of the camera structure 100.

In at least one embodiment, the first position is an end portion of the rotating slope structure 132a away from the suction cup 150, and the second position is an end portion of the rotating slope structure 132a close to the suction cup 150. In this embodiment, the first position may be the top portion of the rotating slope structure 132a, and the second position may be the bottom portion of the rotating slope structure 132a.

Thus, when the rotating disk 131 is rotated to move the clamping disk 132 from the second position to the first position, the clamping disk 132 extends relative to the rotating disk 131. Therefore, while the axial position of the rotating disk in the camera structure 100 remains unchanged, the extension of the clamping disk 132 relative to the rotating disk 131 can provide greater compressive force to the suction cup 150. Conversely, when the rotating disk 131 is rotated to move the clamping disk 132 from the first position back to the second position, the clamping disk 132 retracts relative to the rotating disk 131. In this case, while the axial position of the rotating disk 131 in the camera structure 100 remains unchanged, the retraction of the clamping disk 132 relative to the rotating disk 131 reduces the compressive force on the suction cup 150, weakening the adsorption force between the suction cup 150 and the carrier. This facilitates the removal of the camera structure 100 from the carrier, completing the detachment operation. By controlling the extension and retraction of the clamping disk 132 through the rotating disk 131, the compressive force on the suction cup 150 can be flexibly adjusted to meet the needs of the camera structure 100 in different usage scenarios. This ensures stable adsorption on the carrier during operation while allowing easy detachment when needed, significantly improving the convenience and practicality of the camera structure 100's use.

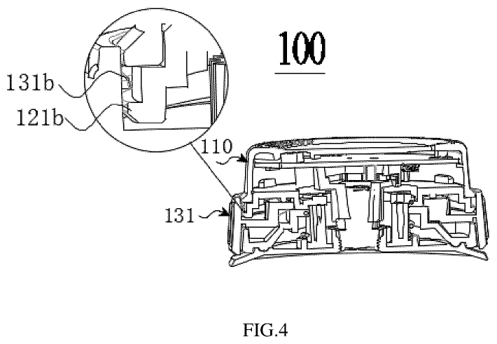

Please referring to FIGS. 4 and 5 together, FIG. 4 illustrates a cross-sectional view of the camera structure 100 shown in FIG. 1; FIG. 5 illustrates an exploded view of the cross-sectional view shown in FIG. 4. In at least one embodiment, an inner wall of a side of the rotating disk 131 facing the clamping disk 132 can include at least one resisting portion 131a, the at least one resisting portion 131a abuts against slope surface of the at least one rotating slope structure 132a respectively. Here, there are three rotating slope structures 132a and three resisting portions 131a, the respective resisting portion 131a tightly resists on the slope surface of the respective rotating slope structure 132a. During the rotation of the rotating disk 131, the resisting portion 131a moves along the slope surface, allowing the operator to clearly feel the rotation position changes of the rotating disk 131 and the state changes of the locking mechanism 130. This enables precise control over the degree of rotation of the rotating disk 131, ensuring that the locking mechanism 130 achieves optimal performance during both locking and unlocking, and avoiding issues such as insufficient locking or difficulty in unlocking due to improper operation. The number of resisting portions 131a and the number of rotating slope structures 132a can be set according to actual requirements and is not specifically limited here.

Please continue to referring to FIG. 5, the suction cup 150 can include a connecting portion 152 and a suction cup body 153. The suction cup body 153 is annular and surrounds and connects to an outer periphery of the connecting portion 152. The connecting portion 152 protrudes relative to the suction cup body 153 along the axial direction of the camera structure 100, forming a raised shape. The first through hole 151 penetrates the connecting portion 152 along the axial direction of the camera structure 100. The lens 113 of the lens assembly 110 also protrudes relative to the housing 112 along the axial direction of the camera structure 100, forming a raised shape. The lens 113 is inserted through the first through hole 151 and can be exposed from the side of the first through hole 151 opposite to the lens assembly 110, allowing the lens 113 to capture images on the other side of the transparent carrier.

When the lens assembly 110 and the suction cup 150 are coupled, the connecting portion 152 spaces the housing 112 of the lens assembly 110 and the suction cup body 153 of the suction cup 150 apart. The rotating disk 131 and the clamping disk 132 are then sleeved onto the connecting portion 152. Therefore, the rotating disk 131 and the clamping disk 132 are provided with a third through hole 131d and a fourth through hole 132d, respectively, corresponding to the position of the connecting portion 152.

In at least one embodiment, the exterior of the lens 113 can include an external thread structure, and the inner wall of the connecting portion 152 can include an internal thread structure that matches the external thread structure. During installation, the lens 113 is aligned with the first through hole 151, allowing the external thread structure of the lens 113 to initially align with the internal thread structure of the first through hole 151. By rotating the lens 113, the lens 113 and the suction cup 150 are threaded together, forming a stable integrated structure. This ensures the stability of the lens 113 during shooting, preventing displacement due to vibrations or other factors. Additionally, when disassembly or replacement of the lens 113 is required, it can be easily achieved by rotating the lens 113 in the opposite direction, providing convenience for maintenance of the camera structure 100. At the same time, the secure connection between the lens 113 and the suction cup 150 helps maintain the airtightness of the entire camera structure 100, ensuring the adsorption performance of the suction cup 150 and enabling it to stably adhere to the carrier surface.

In at least one embodiment, the lens 113 may also be snap-fitted to the suction cup 150. For example, the outer surface of the lens 113 may be provided with specific snap-fit structures, and the inner wall of the connecting portion 152 may be provided with snap-fit grooves that match the snap-fit structures of the lens 113. The shape and size of the grooves precisely match the snap-fit structures of the lens 113 to ensure a tight connection. The connection method between the lens 113 and the suction cup 150 can be set according to actual requirements and is not specifically limited here.

The lens 113 of the lens assembly 110 protrudes in a raised shape relative to the housing 112 along the axial direction of the camera structure 100 and is inserted through the first through hole 151 of the connecting portion 152 of the suction cup 150. The lens 113 and the first through hole 152 exhibit excellent airtightness, with the outer surface of the lens 113 tightly fitting against the inner wall of the first through hole 151, leaving almost no gap. This effectively prevents external light from entering through the area between the lens 113 and the connecting portion 152 of the suction cup 150, avoiding stray light interference with the lens 113 imaging. Additionally, the connecting portion 152 protrudes in a raised shape relative to the suction cup body 153 along the axial direction of the camera structure 100, further structurally blocking light and reducing the possibility of light diffracting into the lens 113 from the sides. Moreover, the rotating disk 131 and the clamping disk 132 are sleeved onto the connecting portion 152 of the suction cup 150, the rotating disk 131 defines the third through hole 131d, and the clamping disk 132 defines the fourth through hole 132d, both of which fit tightly with the connecting portion 152. During installation, when the rotating disk 131 rotates to cause the clamping disk 132 to compress the suction cup 150, the contact surfaces between the clamping disk 132 and the connecting portion 152 of the suction cup 150, as well as between the rotating disk 131 and the connecting portion 152 of the suction cup 150, further enhance the blocking of light. At the same time, the structural design of the rotating disk 131 and the clamping disk 132 also provides some shielding effect against light that might enter from the sides, reducing the impact of light on the imaging of the lens 113. Furthermore, the housing 112 of the lens assembly 110 and other components of the camera structure 100 can be made of light-blocking materials during design and manufacturing. The housing 112 effectively encloses and protects the interior of the lens assembly 110, preventing external light from entering from sides or back side of the lens assembly 110, where the back side of the lens assembly 110 refers to an opposite side of the lens assembly 110 opposite to a front side where the lens assembly 110 tacking images. In some embodiments, auxiliary measures such as sealing strips can be used to further enhance the light-blocking effect, ensuring that the entire camera structure 100 is not disturbed by external light during operation, thereby enabling the lens 113 to capture clear and accurate images.

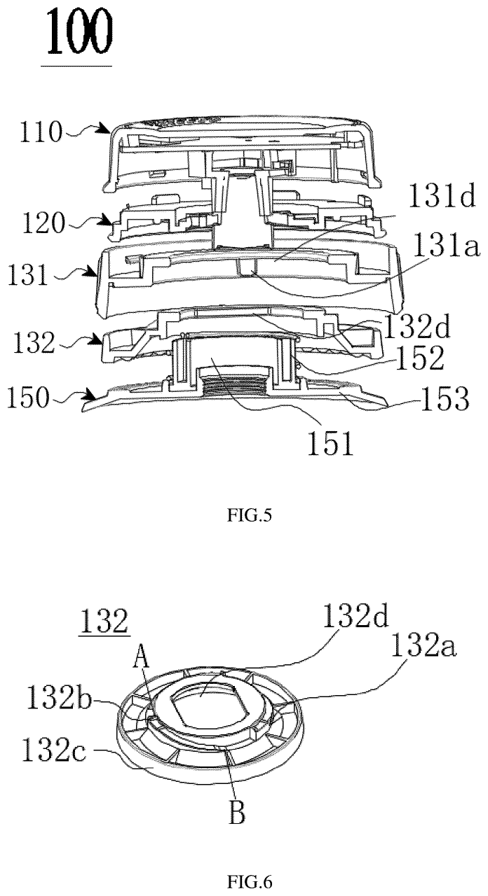

Referring to FIG. 6 together, FIG. 6 illustrates a partial exploded structural view (1) of the camera structure 100 shown in FIG. 2. As shown in FIG. 6, A indicates the first position of the rotating slope structure 132a, and B indicates the second position of the rotating slope structure 132a. The clamping disk 132 can further include a disk structure 132c and a cylindrical structure. The disk structure 132c is annularly connected to the cylindrical structure. The cylindrical structure protrudes axially relative to the disk structure 132c in the direction away from the suction cup 150. The at least one rotating slope structure 132a are located on an outer peripheral wall of the cylindrical structure.

The center of the cylindrical structure is penetrated to form the fourth through hole 132d. The rotating slope structure 132a forms a spiral slope surface. The first position A of the rotating slope structure 132a refers to an end of the rotating slope structure 132a farthest from the disk structure 132c, and the second position of the rotating slope structure 132a refers to the end of the rotating slope structure 132a closest to the disk structure 132c.

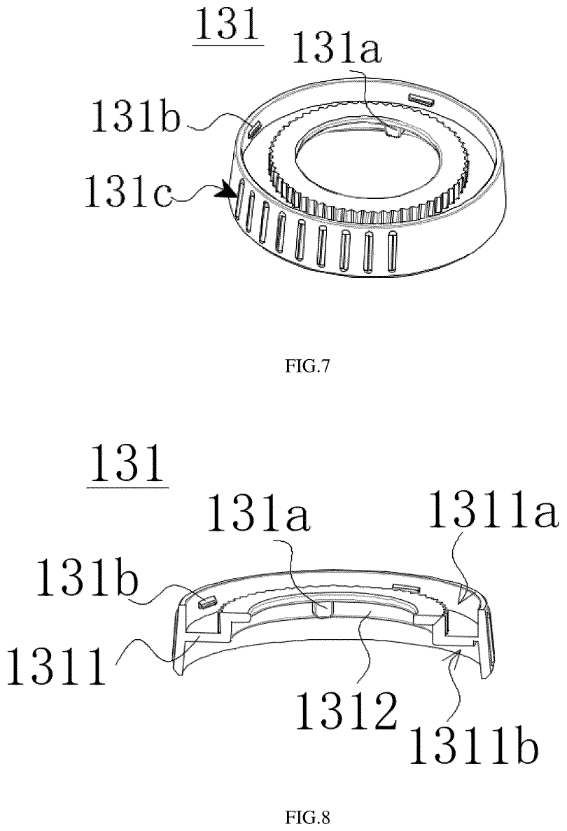

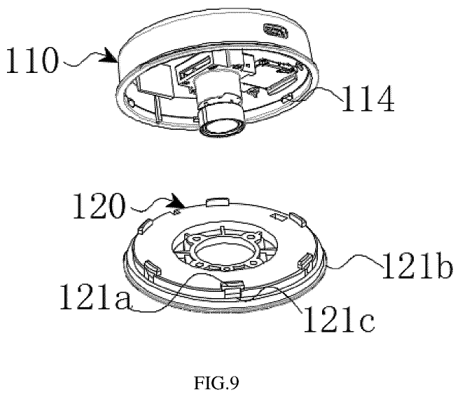

Please referring to FIGS. 7 and 8 together, FIG. 7 illustrates a partial exploded structural view (2) of the camera structure 100 shown in FIG. 2, FIG. 8 illustrates a cross-sectional view of the structure shown in FIG. 7. The rotating disk 131 can include a partition plate 1311, a circular perimeter wall 1312, a first receiving space 1311a, and a second receiving space 1311b. The partition plate 1311 extends radially inward and bends away from the disk structure 132c, forming a Z-shaped bend, thereby dividing an internal space of the rotating disk 131 into a first receiving space 1311a and a second receiving space 1311b. The first receiving space 1311a is configured to accommodate the fixed component 120, thereby achieving the connection between the fixed component 120 and the rotating disk 131. The second receiving space 1311b is configured to cooperate with the disk structure 132c and the rotating slope structure 132a of the clamping disk 132. Thus, when the rotating disk 131 rotates, the clamping disk 132, guided by the rotating slope structure 132a, rotates within the second receiving space 1311b. This rotation enables the clamping disk 132 to compress or release the suction cup 150, thereby adjusting the adsorption force between the suction cup 150 and the surface of the carrier. During camera installation, rotating the rotating disk 131 causes the clamping disk 132 to compress the suction cup 150, enhancing the adsorption force for stable installation. During detachment, rotating the rotating disk 131 in the opposite direction releases the compression force of the clamping disk 132 on the suction cup 150, facilitating the detachment process. By dividing the internal space of the rotating disk 131 into the first receiving space 1311a and the second receiving space 1311b, the layout of components inside the rotating disk 131 is compact and rational, avoiding interference between components. Each component works collaboratively within its respective space, enabling the camera structure 100 to achieve more functions within a limited space.

Please continue to referring to FIGS. 6 and 7, in at least one embodiment, the first position A of the rotating slope structure 132a of the clamping disk 132 can include a stopping member 132b. When the resisting portion 131a is located at the first position A of the rotating slope structure 132a, the resisting portion 131 abuts against the stopping member 132b. The stopping member 132b provides a clear locking indicator for the rotation of the rotating disk 131. When the operator rotates the rotating disk 131 and the resisting portion 131a abuts against the stopping member 132b, the locking mechanism 130 is in the optimal locked state. This further limits the movement range of the clamping disk 132, preventing excessive movement and maintaining the structural stability of the entire locking mechanism 130, thereby extending the service life of the locking mechanism 130.

Referring to FIG. 2, in at least one embodiment, the lens assembly 110 can further include a fixed component 120. The fixed component 120 can define a second through hole 123. The second through hole 123 can penetrate the fixed component 120 in a direction parallel to the axial direction of the lens 113. The fixed component 120 is coupled to the housing 112. The lens 113 passes through the second through hole 123. The fixed component 120 is coupled to the housing 112, for providing additional support for the lens 113. This support structure effectively reduces the lens 113 wobble during use, enhancing the stability of the captured images. Additionally, the second through hole 123 ensures that the lens 113 stably passes through in a direction parallel to the central axis of the second through hole 123, maintaining the positional stability of the lens 113 and further ensuring the accuracy and stability of the captured images. Thus, with the design of the second through hole 123, during assembly, the lens 113 only needs to be inserted through the second through hole 123, and the fixed component 120 is then coupled to the housing 112, completing the preliminary installation of the lens 113 and improving installation convenience.

Referring to FIG. 9 together, FIG. 9 illustrates a partial exploded structural view (3) of the camera structure 100 shown in FIG. 2. In at least one embodiment, the fixed component 120 can include at least one first protrusion 121a spaced apart thereon, and the first protrusion 121a can extend radially outward along the fixed component 120. An inner circumferential wall of the housing 112 can include at least one first engaging structure 114 at corresponding position to match the at least one first protrusion 121a respectively. When the first protrusion 121a is engaged with the first engaging structure 114, the housing 112 and the fixed component 120 are fixedly coupled. Where the first protrusion 121a may be in an inverted L-shape, extending radially outward from the fixed component 120, and the first engaging structure 114 can engage with the opening of the first protrusion 121a, thus abutting against the inner surface of the fixed component 120 and the bottom fixed edge 121c, thereby the first protrusion 121a tightly engaging with the first engaging structure 114, and such that the first protrusion 121a and the first engaging structure 114 can be fixed coupled in the axial direction of the camera structure 100, effectively preventing relative movement of the components under force.

The first protrusion 121a is engaged with the first engaging structure 114 on the inner peripheral wall of the housing 112, effectively prevents relative displacement between the fixed component 120 and the housing 112 during operation. This ensures the structural stability of the lens assembly 110 and maintains the accurate position of the lens 113, avoiding image shaking or offset caused by loose connections. During installation, alignment between the first protrusion 121a of the fixed component 120 and the first engaging structure 114 of the housing 112 can be achieved simply by pressing or rotating, improving assembly efficiency. The number and position of the first protrusion 121a can be adjusted according to different usage scenarios and requirements to accommodate housings and fixed components of different sizes and shapes. For example, when the size of the camera structure 100 is sufficiently large, the size or number of the first protrusion 121a and the first engaging structure 114 can be appropriately increased. The size and number of the first protrusion 121a and the first engaging structure 114 can be set according to actual requirements and are not specifically limited here.

Please also referring to FIGS. 7 and 9 together, in at least one embodiment, a peripheral wall of the fixed component 120 can include a second protrusion 121b continuously distributed along a circumferential direction of the fixed component 120. The second protrusion 121b can extend radially outward from the fixed component 120. An inner peripheral wall of the rotating disk 131 can include at least one second engaging structure 131b at corresponding position to engage with the second protrusion 121b. When the second protrusion 121b is engaged with the at least one second engaging structure 131b, the fixed component 120 and the rotating disk 131 are relatively fixed in an axial direction of the fixed component 120.

When the second protrusion 121b is engaged with the second engaging structure 131b, which can prevent the relative movement between the fixed component 120 and the rotating disk 131 in the axial direction of the camera structure 100. During the use of the camera structure 100, this axial fixation ensures that the positions of all components remain stable, preventing any shift that could affect the shooting angle of the lens 113, thereby guaranteeing the quality and stability of the images captured by the lens 113. Through the engagement of the second protrusion 121b and the second engaging structure 131b, the fixed component 120 and the rotating disk 131 form a stable structure in the axial direction of the camera structure 100. This helps to more effectively transmit the force from the rotating disk 131 to other components during the operation of the locking mechanism 130, enhancing the ability of the locking mechanism 130 to securely connect the suction cup 150 and the lens assembly 110. This ensures that the camera structure 100 can operate reliably even in complex environments.

Please continue to referring to FIGS. 2 and 3, in at least one embodiment, an edge area of the clamping disk 132 near the suction cup 150 can include a plurality of raised dots 132f. The corresponding position of the suction cup 150 near the clamping disk 132 can include a plurality of recessed dots 154 that engage with the plurality of raised dots 132f respectively. When the raised dots 132f are engaged with the recessed dots 154 respectively, the clamping disk 132 moves toward the suction cup 150. The engagement of the plurality of raised dots 132f and recessed dots 154 provides precise positioning between the clamping disk 132 and the suction cup 150. When the raised dots 132f are engaged with the recessed dots 154 respectively, it ensures that the clamping disk 132 accurately covers the suction cup 150, preventing any offset of the clamping disk 132 during installation or use. This ensures the stable and reliable locking effect of the locking mechanism 130 on the suction cup 150, avoiding issues such as reduced or uneven adsorption force due to misalignment of the clamping disk 132, and ensuring that the camera structure 100 remains firmly attached to the surface of the carrier. In some embodiments, only when the raised dots 132f are accurately engaged with the recessed dots 154, the clamping disk 132 can smoothly move toward the suction cup 150 and complete the locking operation. This prevents improper installation that could cause the locking mechanism 130 to malfunction or the suction cup 150 to adsorb unstably.

In at least one embodiment, the edge area of the clamping disk 132 near the suction cup 150 may also be provided with a plurality of recessed dots, while the corresponding position on the suction cup 150 near the clamping disk 132 is provided with a plurality of raised dots. The raised dots may be regularly or irregularly distributed and could be hemispherical, cylindrical, or other three-dimensional shapes suitable for engaging with the recessed dots. The surface of the raised dots may have a certain roughness to increase friction with the recessed dots, preventing relative sliding during use. The shape and size of the recessed dots match those of the raised dots, allowing them to precisely accommodate the raised dots. The depth of the recessed dots is moderate, ensuring that the raised dots can be fully engaged without affecting the overall structural strength and adsorption performance of the suction cup. The inner walls of the recessed dots may be smooth to allow the raised dots to embed smoothly.

Optionally, in at least one embodiment, the edge area of the clamping disk 132 near the suction cup 150 may have both raised dots and recessed dots, distributed alternately. The corresponding position on the suction cup 150 near the clamping disk 132 may also have alternately distributed raised dots and recessed dots, matching those on the clamping disk. The shape and size of the raised dots and recessed dots on the suction cup 150 match those on the clamping disk 132 to ensure a tight fit. When the clamping disk 132 is coupled to the suction cup 150, the raised dots on the clamping disk 132 engaged with the recessed dots on the suction cup 150, while the raised dots on the suction cup 150 engaged with the recessed dots on the clamping disk 132. This bidirectional engagement of raised and recessed dots significantly enhances the connection strength and stability between the clamping disk 132 and the suction cup 150, constraining and positioning them in a plurality of dimensions. During the operation of the camera structure 100, this effectively resists various external interferences, ensuring that the camera structure 100 remains stable and improving its reliability and service life.

Please continue to referring to FIG. 2, in at least one embodiment, the locking mechanism 130 can further include an elastic member 140 located between the clamping disk 132 and the suction cup 150. The elastic member 140 can include an elastic spiral component made of elastic materials wound in a spiral. When the rotating disk 131 is rotated along the second direction to the second position, the elastic force of the elastic member 140 causes the clamping disk 132 to retract, releasing the compressive force on the suction cup 150. This makes the detachment of the camera structure 100 easier and improves operational efficiency. The elastic member 140 also serves as a buffer and shock absorber in the locking mechanism 130, effectively reducing friction and wear between components caused by external impacts, thereby extending the service life of the locking components.

In at least one embodiment, the suction cup 150 is formed by dual-color injection molding and can include a hard plastic part and a soft plastic part. The hard plastic part constitutes the connecting portion 152 of the suction cup 150 and the internal structural portion of the suction cup body 153 that provides support. The soft plastic part constitutes the area of the suction cup body 153 that directly contacts the surface of the carrier. When the suction cup 150 comes into contact with the surface of the carrier, the soft plastic part can better contact to the adsorption surface of the carrier, forming a good seal and enhancing the adsorption force of the suction cup 150. The hard plastic part prevents the suction cup 150 from deforming due to external pulling or squeezing during long-term use, ensuring the overall structural stability of the suction cup 150. This allows the suction cup 150 to maintain excellent adsorption performance even under frequent use or significant external forces, extending its service life.

The elasticity of the soft plastic part also provides a certain level of cushioning, preventing damage to the surface of the carrier caused by improper force during installation. The combination of hard and soft plastic enables the suction cup 150 to adapt to various usage scenarios and carrier materials. For example, in scenarios where adsorption onto smooth and easily damaged surfaces is required, the soft plastic part can prevent scratches on the adsorption surface. In situations requiring withstanding significant external forces, the hard plastic part provides sufficient support to ensure the suction cup 150 does not detach. The dual-color injection molding process ensures that the hard and soft plastic parts are tightly integrated into a single unit, enhancing the overall integrity and reliability of the suction cup 150 and reducing potential issues caused by loose connections between components.

Please continue to referring to FIG. 7, in at least one embodiment, the outer peripheral surface of the rotating disk 131 can include a plurality of ribbed protrusions 131c spaced apart. The plurality of ribbed protrusions 131c can be arranged along a circumferential direction of the outer peripheral surface, and a surface roughness of the ribbed protrusions 131c is greater than that of other parts of the outer peripheral surface of the rotating disk 131. As the surface roughness of the ribbed protrusions 131c is greater than that of other parts of the outer peripheral surface of the rotating disk 131, enhances the friction force between the operator's hand and the rotating disk 131. When rotating the rotating disk 131 for locking or unlocking, the operator can grip the rotating disk 131 more securely, avoiding operational errors due to slipping and ensuring smooth rotation of the rotating disk 131, thereby improving operational convenience.

In at least one embodiment, please continue to referring to FIG. 2, the suction cup 150 can include at least one grip part 160, which protrudes radially outward from the suction cup 150. During camera installation, the grip part 160 provides a convenient point for applying force, the operator can hold the grip part 160 to control the suction cup 150 to contact with the surface of the carrier, pressing the suction cup 150 smoothly onto the target position to ensure secure adsorption. For example, in situations requiring installation in high or confined spaces, the grip part 160 makes the operation more convenient and reduces installation difficulty. When detaching the camera structure 100, the operator only needs to pull the grip part 160 outward to overcome the adsorption force between the suction cup 150 and the surface of the carrier, allowing the suction cup 150 to quickly detach from the carrier. This saves effort and avoids damage to the suction cup 150 caused by improper force. The shape, size, or number of grip parts 160 can be set according to actual requirements and is not specifically limited here.

Please continue to referring to FIG. 2, in at least one embodiment, the housing 112 can define a plurality of first holes 170 distributed along a surface of the housing 112. During the working of the lens 113, internal electronic components generate heat, and the first holes 170 provide channels for heat dissipation. The hot air inside the housing 112 can be expelled through the first holes 170, while external cool air can flow in, effectively reducing the internal temperature of the housing 112. This prevents issues such as reduced performance of electronic components or degraded image quality due to overheating, ensuring stable and efficient operation of the lens 113. The shape, size, and number of first holes 170 can be set according to actual requirements. For example, when the camera structure 100 is sufficiently large, the diameter of the first holes 170 can be increased or the number of first holes 170 can be added to further enhance heat dissipation performance. Furthermore, the first holes 170 can be used as acoustic port.

In the above embodiments, the descriptions of each embodiment have their own emphasis. For parts not detailed in a particular embodiment, reference can be made to the relevant descriptions in other embodiments. The embodiments of the present disclosure have been described in detail above, and specific examples have been used to explain the principles and implementation methods of the present disclosure. The descriptions of the above embodiments are intended to help understand the methods and core ideas of the present disclosure. At the same time, for those of ordinary skill in the art, based on the ideas of the present disclosure, there may be changes in specific implementation methods and application scopes. In summary, the content of this specification should not be construed as limiting the application. Any modifications, equivalent replacements, and improvements made within the spirit and principles of the above embodiments shall be included within the protection scope of the technical solution.

What is claimed is:

1. A camera structure, wherein the camera structure comprises:
a lens assembly, wherein the lens assembly comprises a housing, and a lens fixedly coupled inside of the housing;
a suction cup, wherein the suction cup defines a first through hole, the lens is in an interference fit with the first through hole, the suction cup is configured to be adhered to a carrier, enabling the lens assembly to be attached to the carrier; and,
a locking mechanism, wherein the locking mechanism is sleeved on a connecting position of the lens and the suction cup; the locking mechanism at least comprises a rotating disk and a clamping disk, the clamping disk is located between the suction cup and the rotating disk, the clamping disk comprises at least one rotating slope structure;
when the rotating disk is engaged with first position of the at least one rotating slope structure of the clamping disk, the locking mechanism is in a locked state; when the rotating disk is engaged with second position of the at least one rotating slope structure of the clamping disk, the locking mechanism is in an unlocked state.

2. The camera structure according to claim 1, wherein a slope surface of the rotating slope structure is spiral-shaped.

3. The camera structure according to claim 1, wherein when the rotating disk rotates along a first direction, the rotating disk rotates from the second position of the rotating slope structure to the first position of the rotating slope structure; when the rotating disk rotates along a second direction, the rotating disk rotates from the first position of the rotating slope structure to the second position of the rotating slope structure, where the first direction is opposite to the second direction.

4. The camera structure according to claim 1, wherein the first position is an end portion of the rotating slope structure away from the suction cup, and the second position is an end portion of the rotating slope structure close to the suction cup.

5. The camera structure according to claim 2, wherein the first position is an end portion of the rotating slope structure away from the suction cup, and the second position is an end portion of the rotating slope structure close to the suction cup.

6. The camera structure according to claim 3, wherein the first position is an end portion of the rotating slope structure away from the suction cup, and the second position is an end portion of the rotating slope structure close to the suction cup.

7. The camera structure according to claim 1, wherein an inner wall of the rotating disk facing the clamping disk comprises at least one resisting portion, the at least one resisting portion abuts against slope surface of the at least one rotating slope structure respectively.

8. The camera structure according to claim 7, wherein the first position of the rotating slope structure of the clamping disk comprises a stopping member; when the resisting portion is located in the first position, the resisting portion abuts against the stopping member.

9. The camera structure according to claim 1, wherein the lens assembly further comprises a fixed component; the fixed component defines a second through hole, the second through hole penetrates the first component in a direction parallel a central axis of the lens; the fixed component is coupled to the housing; the lens extends through the second through hole.

10. The camera structure according to claim 9, wherein the fixed component comprises at least one first protrusion spaced apart thereon, and the first protrusion extends radially outward along the fixed component; an inner circumferential wall of the housing comprises at least one first engaging structure at corresponding position to engage with the at least one first protrusion respectively; when the first protrusion is engaged with the first engaging structure, the housing and the fixed component are fixedly coupled.

11. The camera structure according to claim 10, wherein a peripheral wall of the fixed component comprises a second protrusion continuously distributed along a circumferential direction of the fixed component; the second protrusion extends radially outward from the fixed component; an inner peripheral wall of the rotating disk comprises at least one second engaging structure at corresponding position to engage with the second protrusion; when the second protrusion is engaged with the at least one second engaging structure, the fixed component and the rotating disk are relatively fixed in an axial direction of the fixed component.

12. The camera structure according to claim 1, wherein an edge area of the clamping disk near the suction cup comprises a plurality of raised dots; an corresponding position of the suction cup near the clamping disk defines a plurality of recessed dots that engage with the plurality of raised dots respectively; when the raised dots are engaged with the recessed dots respectively, the clamping disk moves toward the suction cup.

13. The camera structure according to claim 1, wherein the camera structure further comprises an elastic member located between the clamping disk and the suction cup; the elastic member comprises an elastic spiral component made of elastic material wound in a spiral.

14. The camera structure according to claim 1, wherein the suction cup is made by dual-color injection molding and comprises a hard plastic part and a soft plastic part.

15. The camera structure according to claim 1, wherein an outer peripheral surface of the rotating disk comprises a plurality of ribbed protrusions spaced apart; the plurality of ribbed protrusions are arranged along a circumferential direction of the outer peripheral surface; and a surface roughness of the ribbed protrusions is greater than that of other parts of the outer peripheral surface of the rotating disk.

16. The camera structure according to claim 1, wherein the suction cup comprises at least one grip part, which protrudes radially outward from the suction cup.

17. The camera structure according to claim 1, wherein the housing defines a plurality of first holes distributed along a surface of the housing.
